(19) United States
(12) Patent Application Publication
(10) Pub. No.: US 2013/0091016 A1
(43) Pub. Date: Apr. 11, 2013

(54) Method and System for Providing Location Targeted Advertisements

(71) Applicant: Jon Shutter, Chicago, IL (US)

(72) Inventor: Jon Shutter, Chicago, IL (US)

(21) Appl. No.: 13/270,391

(22) Filed: Oct. 11, 2011

(51) Int. Cl. G06Q 30/02

(52) U.S. Cl. 705/14.58

(57) ABSTRACT

A system for providing an advertisement is disclosed. The system comprises a processor and an advertisement database. The advertisement database includes data representing at least one predefined restricted advertising area including a location of a predefined restricted advertising area. An advertising program executed on the processor is configured to obtain a position of a mobile device, determine whether the position of the mobile device is located within the predefined restricted advertising area, and block providing an advertisement message to the mobile device that is located within the restricted advertising area.

### BACKGROUND OF THE INVENTION

The present invention relates to a method and system for providing advertisements, and more particularly to a method and system for providing location targeted advertisements to mobile devices.

Persons who travel through a geographic region can use different types of mobile or portable computing platforms to obtain various geographically-related features and services. Mobile or portable computing platforms that provide geographically-related features and services include dedicated computing devices and general purpose computing devices. Dedicated computing devices include in-vehicle navigation systems and personal (i.e., portable or hand-held) navigation systems. General purpose computing devices include devices, such as mobile telephones, portable personal computers (e.g., notebook computers, tablets) and personal digital assistants (e.g., PDAs).

Some of the various geographically-related features and services provided by the different types of mobile or portable computing platforms include route calculation and guidance. For example, some mobile or portable computing platforms are able to provide users with an optimum route to travel by roads between locations in a geographic region. Using input from an end user, and optionally from equipment that can determine the end user's physical location (such as a GPS system), a navigation application program used by a mobile or portable computing platform system examines various paths between two locations to determine an optimum route to travel from a starting location to a destination location in the geographic region. The user of the mobile or portable computing platform is then provided with information about the optimum route in the form of instructions that identify the maneuvers required to be taken by the end user to travel from the starting location to the destination location.

Another geographically-related feature provided by some mobile or portable computing platforms is business or person finding services (e.g., electronic yellow or white pages). These services can identify addresses of individuals or businesses. These services can also identify for a user which businesses of a certain type (e.g., Chinese restaurants) are located within a given range (e.g., 3 miles) of a given location.

Although present mobile or portable computing platforms that provide geographically-related features and services are able to provide many useful advantages, there continues to be room for improvement. One area in which there is room for improvement relates to providing information to end users based upon their location. Some types of information, such as advertising, can be more effective or useful if it is restricted to only certain specific locations. For example, a gas station located in Chicago would not advertise to users located in Miami.

Accordingly, it is an objective to deliver advertising to end users who are traveling in a geographic region. One area in which there is room for improvement relates to creating and providing advertisements to the end user of the mobile or portable computing platforms. It would be beneficial to both the advertiser and the users to provide advertisements that are tailored to the location of end users.

### SUMMARY OF THE INVENTION

To address these and other objectives, the present invention comprises a computer implemented method of providing advertisements to mobile devices. The method obtains a position of a mobile device. The method determines whether the position of the mobile device is located within a predefined restricted advertising area. For the mobile device that is located within the restricted advertising area, the method obtains data representing a condition for restricting advertisements to the predefined restricted advertising and provides an advertisement message to the mobile device according to the condition.

According to another aspect, the present invention comprises a system for providing an advertisement. The system comprises a processor, an advertisement database stored on a computer readable medium associated with the processor, and an advertising program executed on the processor. The advertisement database includes data representing at least one predefined restricted advertising area including a location of a predefined restricted advertising area. The advertising program obtains a position of a mobile device, determines whether the position of the mobile device is located within the predefined restricted advertising area, and blocks providing an advertisement message to the mobile device that is located within the restricted advertising area.

### BRIEF DESCRIPTION OF THE DRAWINGS

An exemplary embodiment of the present invention is described herein with reference to the following drawings.

FIG. 1 illustrates an embodiment of a system for providing advertising messages in a geographic region.

FIG. 2 illustrates a more detailed view of an advertising provider of the system for providing advertising messages in a geographic region.

FIG. 3 illustrates a more detailed view of a mobile device of the system for providing advertising messages in a geographic region.

FIG. 4 is a block diagram of an advertisement database.

FIG. 5 illustrates a map of a geographic region that depicts two restricted areas, according to an example embodiment.

FIG. 6 is a block diagram of a restricted area data record.

FIG. 7 is a flow chart for providing advertisements to mobile devices.

FIG. 8 illustrates a map of a geographic region that depicts the location of two mobile devices.

### DETAILED DESCRIPTION OF THE PRESENTLY PREFERRED EMBODIMENTS

I. Advertising System Overview

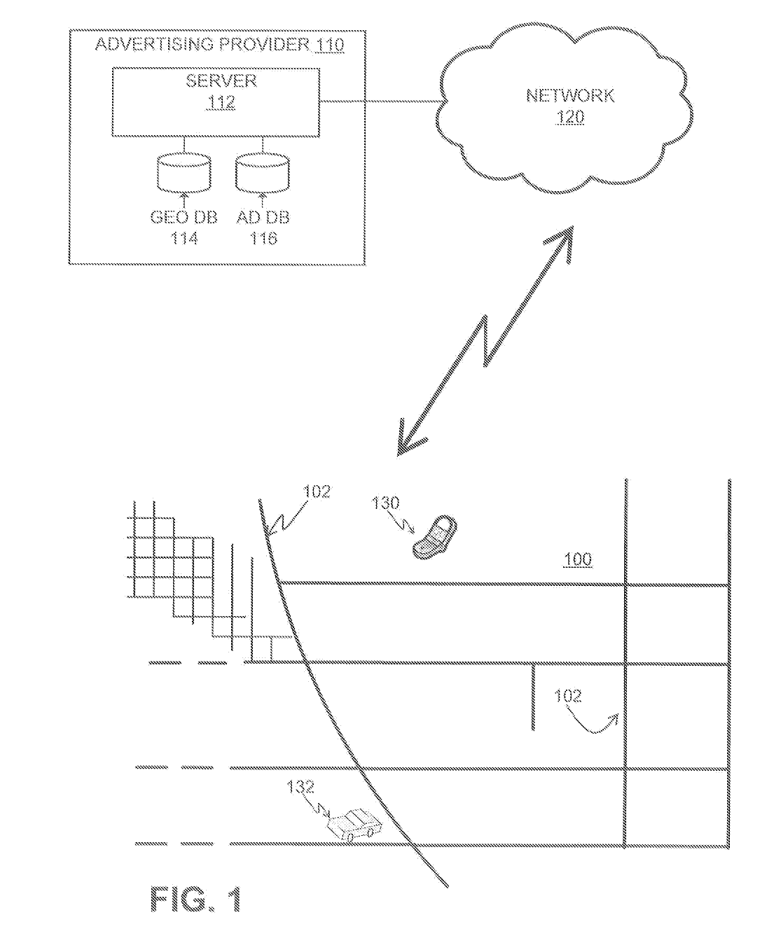

FIG. 1 is diagram illustrating a region 100. The region 100 may be a metropolitan area, such as the New York metropolitan area, the Los Angeles metropolitan area, or any other metropolitan area. Alternatively, the region 100 may be a state, province, or country, such as Illinois, France, or Germany. Alternatively, the geographic region 100 can be a combination of one or more metropolitan areas, states, countries, and so on. Located in the region 100 are a road network and a pedestrian network 102. The road network 102 provides a series of connected road segments and intersections; the pedestrian network comprises sidewalks and pedestrian paths. Furthermore, the region 100 includes a public transit network and bicycle path network.

FIG. 1 illustrates an embodiment of a system for providing advertising messages. The system includes an advertising provider 110, a network 120, and a mobile device 130. The mobile device 130 may be a cellular telephone, a mobile phone, a smart phone, a personal digital assistant (“PDA”), a tablet computer, a laptop, a personal navigation device (“PND”), a portable navigation device, a navigation system built into a vehicle and/or any other electronic device. The mobile device 130 may be associated with vehicles 132 that travel on the road network 102 in the region 100. The vehicles 132 may include a variety of cars, trucks, and motorcycles. The mobile device 130 may also be carried by a pedestrian or person traveling on public transit, bicycle or other mode of transportation.

The mobile device 130 includes suitable equipment that enables them to receive the advertising messages sent by the advertising provider 110. The advertising provider 110 transmits data indicating advertisements for points of interests, such as businesses and facilities including retail stores, restaurants, entertainment facilities, and so on, located in the region 100 or for services that are available in the region 100, sometimes referred to as advertising messages or advertisement messages. The mobile devices 130 that receive the advertising messages may include various different computing platforms.

The advertising provider 110 includes at least a server 112, a geographic database 114 and an advertisement database 116. The network 120 and the communication paths between the advertising provider 110 and the network 120 may be any protocol or physical connection that is used to couple a server to a computer. The communication paths may utilize cellular, Ethernet, wireless, transmission control protocol (TCP), internet protocol (IP), or multiprotocol label switching (MPLS) technologies. In addition, the communication paths between the mobile device 130 and the network 120 may utilize cellular technologies including 3G, 4G, or WiMAX. As used herein, the phrases “in communication” and “couple” are defined to mean directly connected to or indirectly connected through one or more intermediate components. Such intermediate components may include both hardware and software based components.

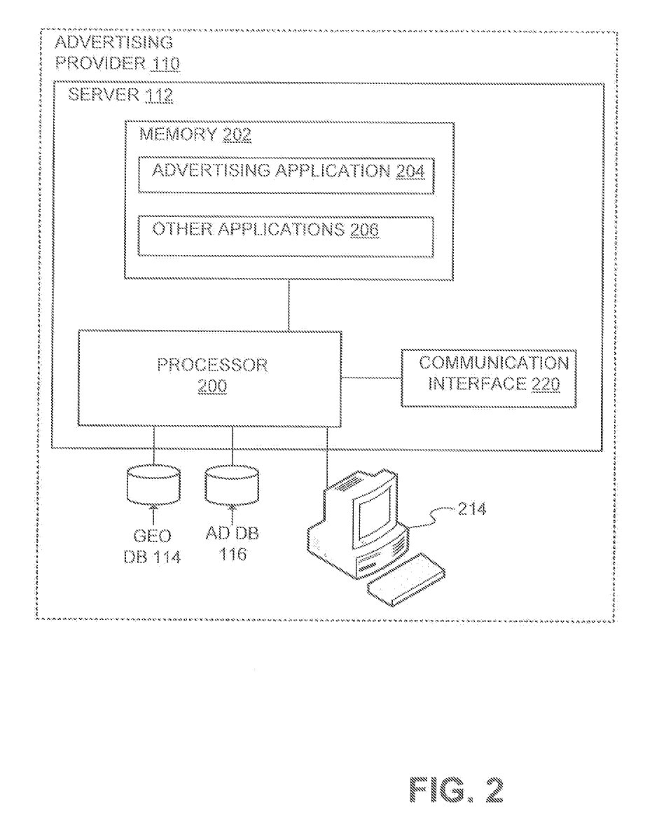

FIG. 2 illustrates a more detailed view of the advertising provider 110 of the system for providing advertising messages. The advertising provider 110 creates, formats and distributes the advertising messages to a plurality of mobile devices 130. The advertising provider 110 includes equipment and programming for creating, formatting and transmitting the advertising messages. Included among the equipment and programming of the advertising system is an advertising server 112. The advertising server 112 includes appropriate computer hardware and software to run network applications. The advertising server 112 is maintained and operated by the advertising provider 110. The advertising server 112 includes a processor 200, memory 202 and a communication interface 220. Additional, different, or fewer components may be used for the advertising server 112.

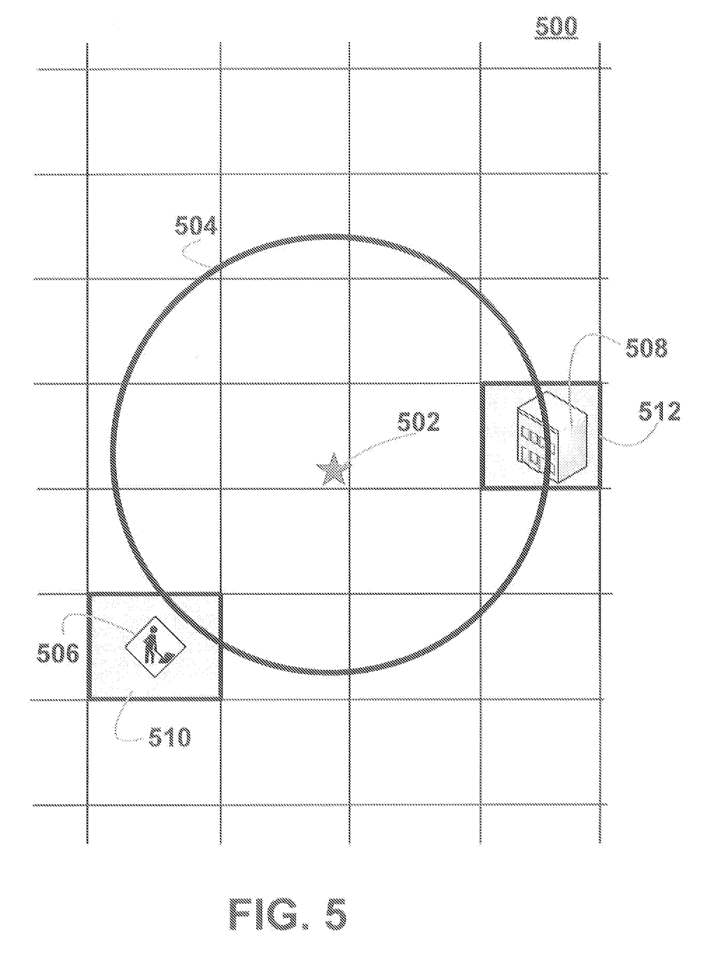

Referring to FIG. 2, server applications are included on the advertising server 112. The server applications may be stored on memory comprising one or more hard drive(s) or other computer readable media operated by the server 112 and loaded into a memory 202 of the server 112 to be executed by the processor 200. One of the server applications is an advertising application 204. The advertising application 204 creates, formats and transmits the advertising message to the mobile device 130. The operation of the advertising application will be discussed in detail in conjunction with FIG. 5 below.

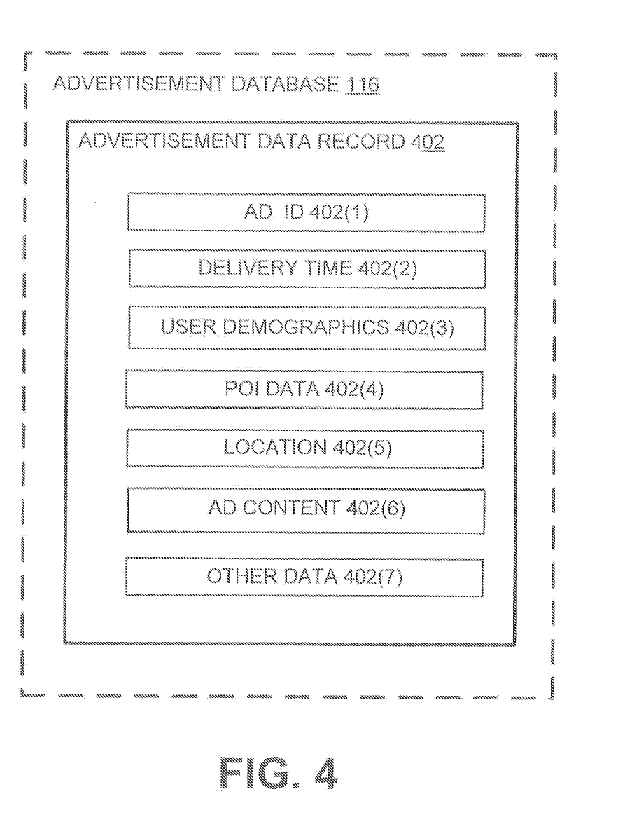

Also associated with the advertising server 112 are the geographic database 114 stored on a computer readable medium and the advertisement database 116 stored on a computer readable medium. The geographic database 114 includes geographic data representing a geographic region. The geographic data may include data representing the road network, pedestrian network, public transportation network, bicycle network and points of interest located in the geographic region. The advertisement database 116 includes data representing advertisements and data representing advertising campaigns. The advertisement database 116 is described in detail below in conjunction with FIG. 4.

Referring to FIG. 2, other server applications 206 may be provided. One example of another server application 206 is a navigation-related server application that may include separate applications (or subprograms) that provide these various navigation features and functions. These functions and features may include route calculation (wherein a route to a destination identified by the end-user is determined), route guidance (wherein detailed directions are provided for reaching a desired destination) and other navigation-related or map-related functions and programming, such as map display, positioning (i.e., map matching), local search, destination selection and so on. The advertising application 204 and the other applications 206 may be written in a suitable computer programming language such as C, although other programming languages, such as C++ or Java, are also suitable.

Referring to FIG. 2, the advertising provider 110 also includes a workstation 214. A representative of the advertising provider 110 may use the workstation 214 to establish advertising campaigns and advertising content for the advertisements database 116. Additionally, the representative may be external to the advertising provider 110 and provide advertising campaigns and advertising content.

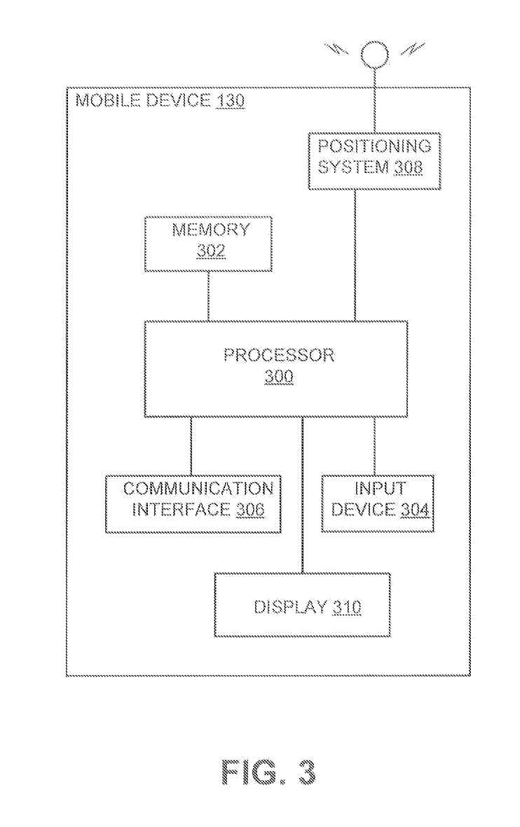

FIG. 3 illustrates a more detailed view of the mobile device 130 of the system for providing advertising messages. The mobile device 130 includes a processor 300, a memory 302, an input device 304, a communication interface 306, a positioning system 308, and a display 310. The processor 300 may be any type of processor suitable for mobile devices and/or computers.

The memory 302 may be a volatile memory or a non-volatile memory. The memory 302 may include one or more of a read only memory (ROM), random access memory (RAM), a flash memory, an electronic erasable program read only memory (EEPROM), or other type of memory. The memory 302 may include an optical, magnetic (hard drive) or any other form of data storage device. The memory 302 may be removable from the mobile device 130, such as a secure digital (SD) memory card.

The input device 304 may be one or more buttons, keypad, keyboard, mouse, stylist pen, trackball, rocker switch, touch pad, voice recognition circuit, or other device or component for inputting data to the mobile device 130. The input device 304 and the display 310 may be combined as a touch screen, which may be capacitive or resistive. The display 310 may be a liquid crystal display (LCD) panel, light emitting diode (LED) screen, thin film transistor screen, or another type of display.

The communication interface 306 may include any operable connection. An operable connection may be one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, software). Logical and/or physical communication channels may be used to create an operable connection. For example, the communication interface 306 may include an output communication interface devoted to sending signals, data, packets, or datagrams and an input communication interface devoted to receiving signals, data, packets, or datagrams. The communication interface 306 provides for wireless and/or wired communications in any now known or later developed format.

The positioning system 308 includes a global positioning system (GPS), cellular, or similar position sensor for providing location data. The positioning system 308 may utilize GPS-type technology, a dead reckoning-type system, or combinations of these or other systems. The positioning system 308 may include suitable sensing devices that measure the traveling distance, speed, direction, and so on, of the device 130. The positioning system 308 may also include appropriate technology to obtain a GPS signal.

In another embodiment, the mobile device 130 may include a geographic database and navigation-related and map-related application software program(s) that provide these various navigation and map features and functions, such as route calculation, route guidance, map display, positioning, local search, destination selection and so on.

### II. Geographic and Advertisement Databases

The geographic database 114 includes geographic data representing features located in a geographic region. The geographic data may include data representing the road network 102 including road segment data and node data. The road segment data represent roads, and the node data represent the ends or intersections of the roads. The road segment data and the node data indicate the location of the roads and intersections as well as various attributes of the roads and intersections. Other formats than road segments and nodes may be used for the geographic data. The geographic data may also represent points of interests (POIs). The POIs may include gasoline stations, hotels, restaurants, museums, stadiums, offices, automobile dealerships, auto repair shops, buildings, stores, statues, monuments, or geographic landmarks. The data representing POIs indicate the location of the POI, including how to access the POI using the road network (or pedestrian network), and various features or attributes of the POI, including hours of operation, telephone number, types of products and services available at the POI, address, and so on. The geographic data may also represent pedestrian features including pedestrian paths, sidewalks, crosswalks, parks, plazas and so on. The geographic data may also represent public transit networks and bicycle networks. The geographic database 114 may be produced and/or maintained by a map developer, such as NAVTEQ North America, LLC located in Chicago, Ill.

In order to provide advertising messages, the advertising provider 110 uses the advertisement database 116 that includes data representing advertisements and data representing advertising campaigns. Referring to FIG. 4, the advertisement database 116 contains advertisement data records 402 that represent content and campaign information for the advertisements or advertising messages. The advertisement data 402 includes an advertisement ID 402(1) by which the advertisement data can be identified in the advertisement database 116. Each advertisement data record 402 has associated with it information that provide information regarding the advertising campaign and the content for the advertisement message.

Referring to FIG. 4, the advertisement data 402 includes data that indicate conditions on the delivery of the advertisement and that provide guidelines and information for the advertising campaign. In one embodiment, the advertisement data 402 provides how the advertisement will be targeted to mobile devices 130. In one embodiment, the advertisement data 402 include data representing delivery time 402(2) or when the advertisement should be delivered, such as time of the day for delivery, between certain hours of the day, on certain days of the week, and so on.

The advertisement data 402 also includes data representing user demographics data 402(3) for targeted recipients for the advertisement. The user demographic data 402(3) indicates what characteristics, such as age, sex, education level, family type, income level and so on, the intended targeted users possess. For example, the demographic data may indicate that the advertisement should be targeted to females between the ages of 30 to 40 years old. Additionally, the demographics data 402(3) may include defined user preferences, defined interests and behavioral patterns.

The advertisement data 402 includes POI data 402(4) that identifies the point of interest associated with the advertisement, such as an ID of a point of interest that identifies the point of interest represented in the geographic database 114. The point of interest associated with the advertisement is typically a business, such as a retail establishment, restaurant, service establishment and so on. The POI data 402(4) provides the location of the point of interest associated with the advertisement, such as an address, latitude and longitude position, or other location reference system. The POI data 402(4) may also provide further information regarding the point of interest, such as business hours, point of interest category, telephone number, website, and other details regarding the point of interest.

The advertisement data 402 includes location data 402(5) representing locations for delivery of the advertisement or where the mobile device is located to be targeted with the advertisement, such as to any mobile device 130 in the geographic region, to mobile devices located in a defined portion of the geographic region, such as within an administrative area, a region defined by a polygon or a circle centered on a defined point location, and so on. In one embodiment, the advertisement is targeted based on the mobile devices' real time or current locations. In another embodiment, the advertisement is targeted based on the mobile devices' expected future locations or past locations.

The location data 402(5) may specify a geo-fenced area or a defined area called an advertisement area, and the advertisement is to be sent to mobile devices 130 located within the geo-fenced area or advertisement area and not to the mobile devices located outside of the geo-fenced area or advertisement area. In one embodiment, the location data 402(5) defines a portion of the geographic region as the area for location targeting the advertisement.

FIG. 5 illustrates a map of a geographic region 500 that will be used to illustrate the advertisement area. A point of interest 502 is located in the geographic area 500 and the advertisement associated with the point of interest 502 has an advertisement area 504 that defines the boundary or boundaries of the portion of the geographic region for location targeting the advertisement. For example, the point of interest 502 is a coffee shop and its base advertisement area 504 is a circular area having a radius of one half mile centered on the location of the coffee shop 502. The base advertisement area 504 may be defined considering travel distance and or travel time from the boundary of the geo-fence to the location of the point of interest.

Referring to FIG. 4, the advertisement data 402 also includes data representing content 402(6) for the advertising message, such as text, audio, images and video. The content 402(6) may also include an incentive with an associated value or other offer to encourage the advertising recipient to visit the associated point of interest or request the associated service. The advertisement data 402 includes more than one version of advertisement content 402(6) for the advertising message. In one embodiment, the advertisement content 402(6) includes data representing content for the advertisement that comprises an interactive graphical display that requires significant attention from the recipient and data representing scaled back content, such as a simple text display, for the advertisement that requires much less attention from the recipient.

The advertisement data 402 includes other data 402(7). Other data 402(7) may indicate key words that would trigger the advertising message, such as a user requesting a restaurant. Additionally, the other data 402(7) may include pricing information for the advertisement.

Although providing advertising messages has numerous benefits to both the advertising provider 110 and recipient, there are certain locations and certain situations in which the advertising provider 110 may wish not to provide advertising messages to the mobile device 130. For example, the location based advertising messages may provide unsafe and unwanted distractions at certain locations and in certain situations. Referring to FIG. 5, a construction site 506 is located within the geographic region 500. Workers or other individuals at the construction site 506 are in a hazardous environment and distractions may pose a danger. Accordingly, providing location based advertising messages to mobile devices 130 located at the construction site 506 may pose a risk to the recipient. Additionally, other locations exist in which location based advertisements may cause unwanted distractions, such as air traffic control towers, government facilities, prisons and so on. At some locations, it is desirable to restrict the type of recipient that is targeted with the advertisement or limit the times of day that the advertisement will be sent. Referring to FIG. 5, a school 508 is located within the geographic region 500. Students at the school do not need distractions provided by location based advertisements during the school day; however, school staff members do not need to be protected from unsolicited advertisements.

Because there are locations in the geographic region that should not be freely targeted with advertisements, the advertising provider 110 defines those portions of the geographic region as restricted areas. Referring to FIG. 5, the construction site 506 has an associated restricted area 510. In one embodiment, the restricted area takes the boundaries of the point of interest associated with the area. The school 508 has an associated restricted area 512 encompassing the school grounds. In another embodiment, third parties, such as government agencies or operators of points of interest, may request the advertising provider 110 to create restricted areas.

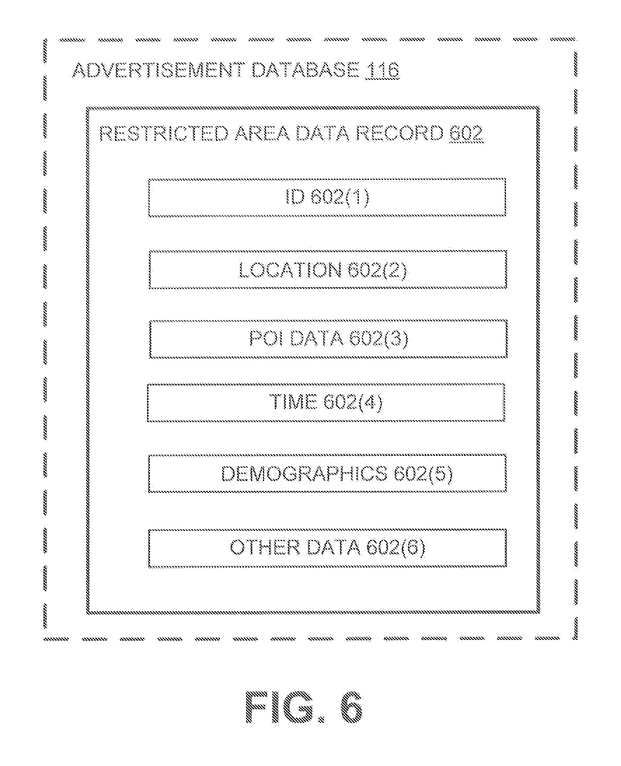

Referring to FIG. 6, the advertisement database 116 contains restricted area data records 602 that represent the restricted areas and attributes for the restricted areas. The advertisement data 602 includes an ID 602(1) by which the restricted area data can be identified in the advertisement database 116.

The restricted area data 602 includes location data 602(2) representing location of the restricted area, such as within a region defined by a polygon or a circle centered on a defined point location, and so on. The location data 602(5) may specify a geo-fenced area, such as the boundaries or footprint of the point of interest or a specified distance from the boundaries of the point of interest. Referring to FIG. 5, the location data 602(2) indicates that area within the boundaries of the construction site 506 is the restricted area 510 associated with the construction site 506. The location data 602(2) indicates that the area within the boundaries of the school 508 is the restricted area 512 associated with the school 508.

The restricted area data 602 includes POI data 602(3) that identifies the point of interest associated with the restricted area, such as an ID of a point of interest that identifies the point of interest represented in the geographic database 114. The POI data 602(3) provides the location of the point of interest, such as an address, latitude and longitude position, or other location reference system. The POI data 602(3) may also provide further information regarding the point of interest, such as business hours, point of interest category and other details regarding the point of interest.

Referring to FIG. 6, the restricted area data 602 includes data that indicate restrictions conditions on the delivery of the advertisements in the restricted area. In one embodiment, the restricted area data 602 include data representing delivery time restrictions 602(4) or when the advertisement should not be delivered to mobile devices located within the restricted area, such as time of the day for delivery, between certain hours of the day, on certain days of the week, and so on. In one embodiment the time restriction data 602(4) indicates that no advertisements should be sent to mobile devices 130 located in the restricted area at all times. For the example of the construction site 506, the time data 602(4) indicates that at all times no advertisements should be sent to mobile devices 130 located in the restricted area 510.

The restricted area data 602 also includes data representing user demographics restrictions data 602(5). The user demographic restrictions data 602(5) indicates characteristics of users whom should not be sent advertisements when their respective mobile devices 130 are located within the restricted area. The demographics include age, sex, education level, profession, family type, income level and so on. For example, the demographic restriction data 602(5) may indicate that the advertisements should not be sent to students or users having an age less than nineteen years old that are located within the restricted area 512.

The restricted area data 602 includes other data 602(6). Other data 602(6) may indicate other characteristics or restrictions for the represented restricted area. For example, the other data 602(6) may indicate the types of advertising content that are not to be sent to mobile devices 130 located within the restricted area, such as advertisements with video and interactive content. The other data 602(6) may also indicate that advertisements for certain categories of points of interest should not to be sent to mobile devices 130 located within the restricted area, such as advertisements for bars or casinos.

III. Providing Advertisements to Mobile Devices

As discussed above in conjunction with FIG. 2, the advertising provider 110 includes the advertising program 204 that provides advertisement messages for various mobile devices 130. In one embodiment, the advertising program 204 determines whether the mobile devices 130 are located in restricted areas and blocks advertisements according to any restrictions for the corresponding restricted area.

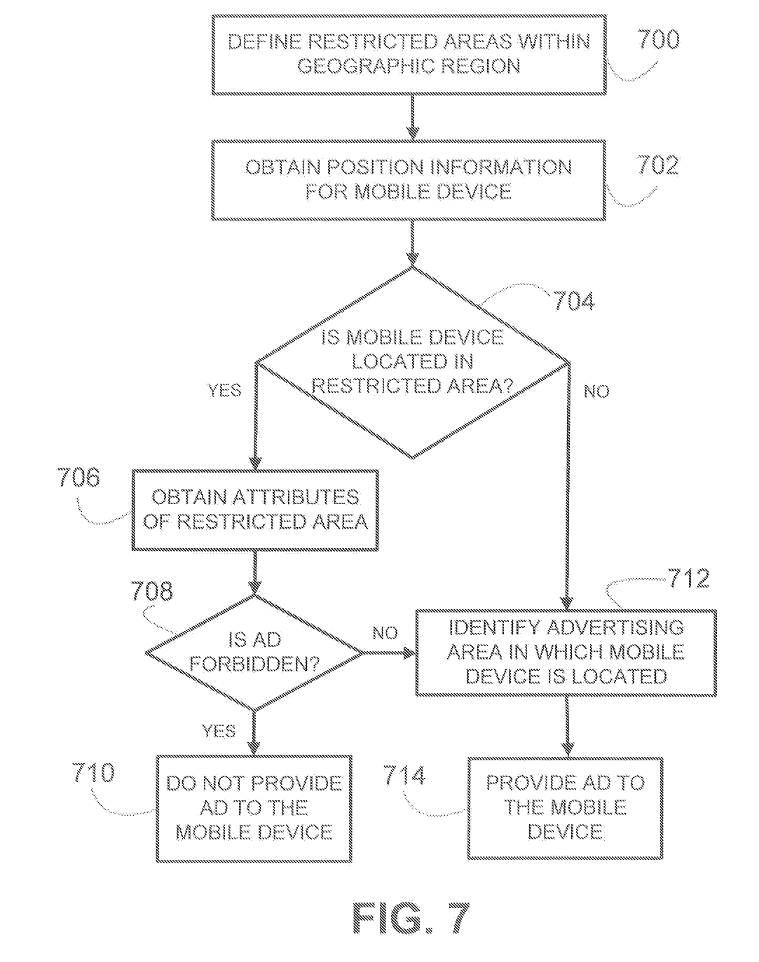

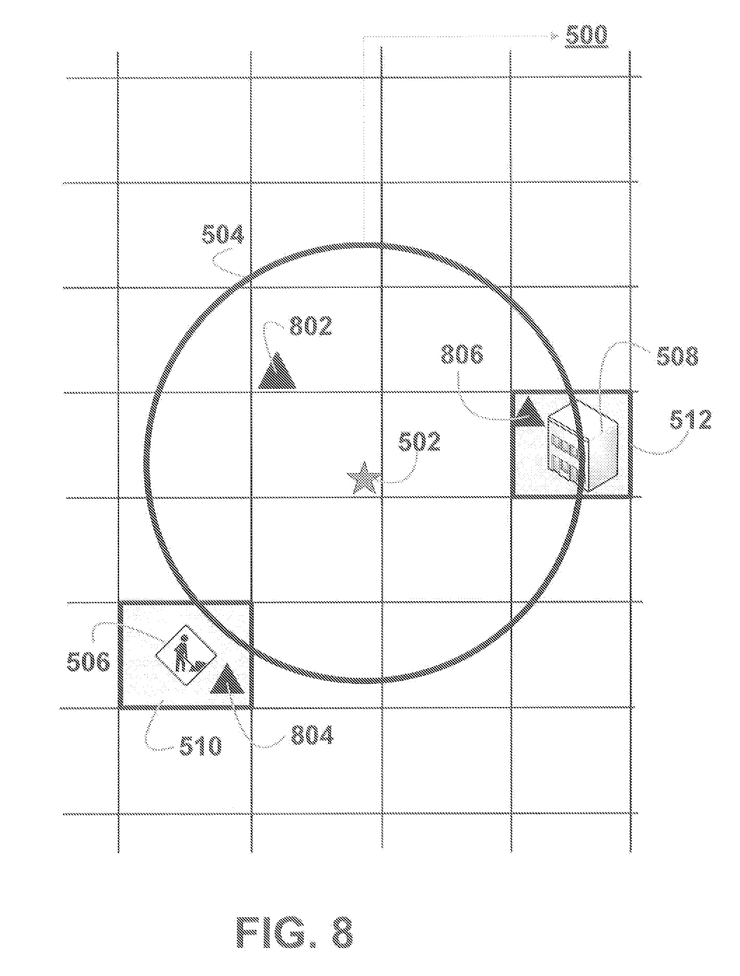

FIG. 7 illustrates a flow chart of the steps for providing a location based advertisement according to one exemplary embodiment. FIG. 8 illustrates a map of a geographic region 500 that will be used to illustrate the steps discussed in conjunction with FIG. 7.

At step 700, the advertising program 204 defines the locations in the geographic region that should not be freely targeted with advertisements as restricted areas. Referring to FIG. 8, the construction site 506 is defined as a restricted area 510. The school 508 is defined as a restricted area 512. Additionally, the advertising program 205 defines the restrictions on advertisements to the restricted areas, such as by time and user demographics. In one embodiment, the restricted areas and associated restrictions on advertisements are predefined and represented by restricted area data records 602 of the advertisement database 116. Alternatively, the restricted areas and corresponding restrictions may be defined in real time.

At step 702, the advertising program 204 obtains position information for a mobile device 130. The positioning system 308 determines the location, direction, orientation and/or speed of the mobile device. In another embodiment, the server 112 may obtain the position information for the mobile device by triangulation or other cellular phone positioning method as well as by WiFi positioning. The current position may be provided to the server 112 in terms of latitude and longitude coordinates or determined by the server 112. In one embodiment, the mobile device 130 runs an application that requests an advertisement from the server 112 and includes an identification of the mobile device 130 as well as the current position information and/or demographics information of the user of the mobile device with the request to the server 112. Using the current position information, the advertising program 204 may identify on which road segment or pedestrian segment that the mobile device 130 is currently traveling on by map matching.

In another embodiment, the position information of the mobile device 130 is a likely future position. For example, the advertising program 204 obtains position information indicating travel plans to another city on a future date, and the destination of the travel plans is used as the position of the mobile device 130. In a further embodiment, the position may be determined by analyzing historic position data. The position data for the mobile device from many weeks may be analyzed to determine a pattern of travel and locations regularly visited. For example, by analyzing past position data, the advertising program may determine that the mobile device 130 is located within an office building every weekday from 9 am to 5 pm.

At step 704, the advertising program 204 determines whether the mobile device 130 is located within one of the defined restricted areas. The advertising program 204 obtains data representing the location of the restricted areas 602(2) from the advertisement database 116. In one embodiment, the position information of the mobile device is compared to the boundaries of the restricted area to determine if the position of the mobile device is within the restricted area. For the example shown in FIG. 8, a mobile device 802 is not located within one of the defined restricted areas 510 and 512 in the geographic region 500. Mobile device 804 is located within the restricted area 510 associated with the construction site 506, and mobile device 806 is located within the restricted area 512 associated with the school 508. If the mobile device (804 and 806) is located within one of the defined restricted areas, the advertising program goes to step 706. If the mobile device (802) is not located within one of the predefined restricted areas, the advertising program goes to step 712.

At step 706, the advertising program 204 obtains attributes representing any restrictions on the delivery of advertisements from the restricted area data record 602 representing the restricted area. In one embodiment, the advertising program 204 obtains data representing delivery time restrictions 602(4). For the example of the construction site 506, the time data 602(4) indicates that at all times no advertisements should be provided to mobile devices 130 located in the restricted area 510. In another embodiment, the advertising program 204 obtains data representing user demographics restrictions data 602(5). For the example of the school 508, the demographic restriction data 602(5) indicate that the advertisements should not be sent to students or users having an age less than nineteen years old that are located within the restricted area 512. In another embodiment, the advertising program obtains other data 602(6) that indicates other characteristics or restrictions for the represented restricted area. For example, the other data 602(6) may indicate the types of advertising content that are not to be sent to mobile devices 130 located within the restricted area, and the categories of points of interest should not to be sent to mobile devices 130 located within the restricted area.

At step 708, the advertising program 204 determines whether all advertisements are forbidden to be provided to the mobile device located within the restricted area. To make this determination, the advertising program 204 evaluates the attributes of the restricted area obtained in step 706. For example, the time data 602(4) indicates that at all times no advertisements should be provided to mobile devices 130 located in the restricted area 510 associated with the construction site 506, so the advertising program proceeds to step 710. For example, the demographic restriction data 602(5) indicate that the advertisements should not be sent to students or users having an age less than nineteen years old that are located within the restricted area 512 associated with the school 508. In this case, the advertising program 204 evaluates demographic information of the user of the mobile device 806 that is located within the restricted area 512. For example, the user of the mobile device 806 is forty-six year old. Accordingly, the advertisement program 204 determines that advertisements are not forbidden for the mobile device 806, and the advertising program goes to step 712.

At step 710, the advertising program 204 does not provide an advertisement to the mobile device 806 located in the restricted area 510 associated with the construction site 506. Alternatively, the advertising program 204 may provide an advertisement to the mobile device 806 for storage in memory 302; however, the advertisement will not be presented on the display 310 of the mobile device 806 when the mobile device 806 is located within the restricted area 510. Once the positioning system 308 determines that the mobile device 806 has left the restricted area 510, the advertisement is provided to the user of the mobile device 806 via the display 310.

At step 712, the advertising program 204 identifies an advertisement area in which the mobile device is located. The advertising program 204 obtains data representing the location of the advertising area 402(5) of candidate advertisements from the advertisement database 116. In one embodiment, the position information of the mobile device is compared to the size and position of the advertisement area to determine if the position of the mobile device is within the boundaries of the advertisement area. For the example shown in FIG. 8, a point of interest 502 has an associated advertisement area 504, and the mobile devices 802 and a mobile device 806 are located with the advertisement area 504.

Because the mobile devices 802 and 806 are located within the advertisement area 504, the advertising program 204 formats an advertisement for the point of interest 502 associated with the advertising area 504. In another embodiment, the advertising program 204 selects the advertisement based on advertising campaign information included in the advertisement data record such as delivery time data 402(2), and user demographics data 402(3). In another embodiment, the advertising program 204 selects the advertisement based on advertising campaign information included in the advertisement data record such as delivery time data 402(2), and user demographics data 402(3). In one embodiment, the advertising provider 110 maintains a database representing characteristics of user of the mobile device including user demographics data.

At step 714, the advertising program 204 provides the advertisement to the mobile device. The advertising program 204 creates the advertisement message using the advertising content data 402(6)(1). The advertising program 204 may select the content of the advertisement, such as less distracting content, based on the restrictions of corresponding restricted area that the mobile device is located in. The advertisement message is transmitted to the mobile device 130 from the server 112 over the network 140. Once the mobile device 802 and 806 receive the advertisement message, the advertisement message is provided to the user via the display 310 and/or other user interface of the mobile device. In one embodiment, the advertisement message is stored in memory 302 of the mobile device, and an application running on the mobile device 130 provides the advertisement to the end user of the mobile device. The end user views and interacts with the advertisement message via the display and user interface of the mobile device. For example, the end user may click to a landing page associated with the advertisement message, click to the coupon provided by the advertisement message, click to obtain a map displaying the point of interest associated with the advertisement message, click to call the point of interest associated with the advertisement message, click for directions to the point of interest associated with the advertisement message and/or click to obtain a website of the point of interest associated with the advertisement message. The messages communicating the users' response to the advertisement are provided to the mobile devices and provided to the user via the display 310 and/or other user interface of the mobile device 130. In one embodiment, the mobile device 130 may request additional information from the server 112, such as directions to the point of interest. Additionally, the server 112 may track the position of the mobile devices to determine that the devices visit the point of interest and or redeem the offer of the advertisement message. Moreover, the advertising program 204 tracks the user response to the advertisements as well as whether the incentive or coupon is redeemed. The advertising program 204 may use information from tracking the user responses to the advertisements to improve the incentive amounts offered and determined appropriate incentive amounts and attribute combinations.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

I claim:

1. A system for providing an advertisement comprising:
a processor,
an advertisement database stored on a computer readable medium associated with the processor, wherein the advertisement database includes data representing at least one predefined restricted advertising area including a location of a predefined restricted advertising area, and
an advertising program executed on the processor, wherein the advertising program configured to obtain a position of a mobile device, determine whether the position of the mobile device is located within the predefined restricted advertising area, and block providing an advertisement message to the mobile device that is located within the restricted advertising area.

2. The system of claim 1 wherein the predefined restricted advertising area corresponds to a portion of the geographic region in which viewing the advertisement message on a display of the mobile device poses a safety hazard to a user of the mobile device.

3. The system of claim 1 wherein the predefined restricted advertising area corresponds to a portion of the geographic region in which viewing advertisement message on a display of the mobile device poses an inappropriate distraction to a user of the mobile device.

4. The system of claim 1 wherein the advertising program provides the advertisement message on a display of the mobile device when the mobile device is no longer located within the restricted advertising area.

5. A computer implemented method of providing advertisements to mobile devices, the method comprising:
obtaining a position of a mobile device;
determining whether the position of the mobile device is located within a predefined restricted advertising area;
for the mobile device that is located within the restricted advertising area, obtaining data representing a condition for restricting advertisements to the predefined restricted advertising area from a database stored on a computer readable medium; and
providing an advertisement message to the mobile device according to the condition.

6. The method of claim 5 wherein the condition for restricting advertisements to the predefined restricted advertising area is time based.

7. The method of claim 5 wherein the condition for restricting advertisements to the predefined restricted advertising area is based on demographic information of the user of the mobile device.

8. The method of claim 5 wherein the condition for restricting advertisements to the predefined restricted advertising area is forbidding all advertisement messages.

9. The method of claim 5 wherein the condition for restricting advertisements to the predefined restricted advertising area is based on a type of point of interest associated with the advertisement message.

10. The method of claim 5 wherein the condition for restricting advertisements to the predefined restricted advertising area is based on a content included in the advertisement message.

11. The method of claim 5 wherein the predefined restricted advertising area corresponds to a portion of the geographic region in which viewing advertisement message on a display of the mobile device poses a hazard to the user of the mobile device.

12. The method of claim 5 wherein the predefined restricted advertising area corresponds to a portion of the geographic region in which viewing advertisement message on a display of the mobile device poses an inappropriate distraction to the user of the mobile device.

13. A system for providing an advertisement comprising:
a processor,
an advertisement database stored on a computer readable medium associated with the processor, wherein the advertisement database includes data representing at least one predefined restricted advertising area including a location of a predefined restricted advertising area and a condition for restricting advertisements to the predefined restricted advertising area, and
an advertising program executed on the processor, wherein the advertising program configured to obtain a position of a mobile device, determine whether the position of the mobile device is located within a predefined restricted advertising area, for the mobile device that is located within the restricted advertising area, obtain data representing the condition for restricting advertisements to the predefined restricted advertising area, and provide an advertisement message to the mobile device according to the condition.

14. The system of claim 13 wherein the condition for restricting advertisements to the predefined restricted advertising area is time based.

15. The system of claim 13 wherein the condition for restricting advertisements to the predefined restricted advertising area is based on demographic information of the user of the mobile device.

16. The system of claim 13 wherein the condition for restricting advertisements to the predefined restricted advertising area is forbidding all advertisement messages.

17. The system of claim 13 wherein the condition for restricting advertisements to the predefined restricted advertising area is based on a type of point of interest associated with the advertisement message.

18. The system of claim 13 wherein the condition for restricting advertisements to the predefined restricted advertising area is based on a content included in the advertisement message.

19. The system of claim 13 wherein the predefined restricted advertising area corresponds to a portion of the geographic region in which viewing advertisement message on a display of the mobile device poses a hazard to the user of the mobile device.

20. The system of claim 13 wherein the predefined restricted advertising area corresponds to a portion of the geographic region in which viewing advertisement message on a display of the mobile device poses an inappropriate distraction to the user of the mobile device.
